(19) United States
(12) Patent Application Publication
(10) Pub. No.: US 2007/0292569 A1
(43) Pub. Date: Dec. 20, 2007

(54) Packaging material for food items containing permeating oils

(76) Inventors: Reinhard D. Bohme, Vancouver, WA (US); John Cameron Files, Vancouver, WA (US)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(21) Appl. No.: 11/824,175

(22) Filed: Jun. 28, 2007

Related U.S. Application Data
(63) Continuation-in-part of application No. 11/477,264, filed on Jun. 29, 2006.
(63) Continuation-in-part of application No. PCT/US06/25557, filed on Jun. 29, 2006.
(60) Provisional application No. 60/695,145, filed on Jun. 29, 2005.
(60) Provisional application No. 60/817,488, filed on Jun. 29, 2006.

(51) Int. Cl. B32B 27/00

(52) U.S. Cl. 426/127; 141/98; 428/515

(57) ABSTRACT

A packaging material for oily or greasy food items includes one or more features for resisting penetration, masking penetration, or for a combination of resisting and masking penetration by the oily or greasy substance.

### CROSS-REFERENCE TO RELATED APPLICATIONS

This application is a continuation-in-part of U.S. application Ser. No. 11/477,264, filed Jun. 29, 2006, and PCT Application No. PCT/US2006/025557, filed Jun. 29, 2006, which claims the benefit of U.S. Provisional Application No. 60/695,145, filed Jun. 29, 2005, and this application further claims the benefit of U.S. Provisional Application No. 60/817,488, filed Jun. 29, 2006, each of the above applications being incorporated by reference in its entirety.

### TECHNICAL FIELD

The present invention relates generally to packaging materials and, more particularly, relates to packaging materials for food items containing a permeating oil.

### BACKGROUND

Paper-based bags and cartons frequently are used to package frozen food items, such as French fries, hash browns, and breaded chicken. However, such products often are coated with oils that are capable of permeating the paper or paperboard. When oils penetrate the packaging, a darkened area or stain appears on the outside of the carton. Such staining detracts from the appearance of the packaging, which may be viewed as damaged or contaminated.

Recently, interest in low or non-trans fatty acid oils has increased because these oils are viewed as healthier than other oils. However, unlike other oils, which freeze at typical freezer temperatures, the non- or low trans fatty acid oils remain fluid, thereby causing greater staining to the package. Thus, there remains a need for packages and packaging materials that prevent staining by oils, mask staining by oils, or any combination thereof.

### SUMMARY

Various aspects of the present invention relate generally to a packaging material for oily or greasy food items, and methods of making such packaging materials. The various packaging materials include features for resisting penetration, masking penetration, or for both resisting and masking penetration by one or more oily or greasy substances (hereinafter “oil” or “oils”) associated with some food items.

According to one aspect, the present invention relates to an oil resistant packaging material comprising a substrate that is susceptible to discoloration by an oil, and an oil resistant layer substantially overlying the substrate, where the oil resistant layer comprises a polymer that is substantially resistant to penetration by oil. The oil resistant layer may have any suitable basis weight, for example, from about 1 to about 10 lbs/ream (lb/3000 sq. ft.), or from about 2 to about 6 lbs/ream.

The oil resistant layer may comprise a single polymer, for example, polypropylene, or may comprise a blend of two or more polymers. In one example, the oil resistant layer comprises from about 50 to about 99 wt % polypropylene and up to about 50 weight (wt) % low density polyethylene, propylene-ethylene copolymer, polyethylene terephthalate, nylon 6,6, polyvinylidene chloride, polyvinyl alcohol, ethylene vinyl alcohol, or any combination thereof. If desired, the oil resistant layer may include a filler. In one example, the oil resistant layer may include from 0 to about 30 wt % filler. In another example, the packaging material includes a substrate comprising paper or paperboard, and an oil resistant layer comprising polypropylene and a filler selected from the group consisting of calcium carbonate, magnesium carbonate, silica, calcium oxide, alumina, titanium dioxide, or any combination thereof.

In one variation of this aspect, the packaging material includes a heat seal layer substantially overlying the oil resistant layer. The heat seal layer may be, for example, a thermoplastic polymer having a softening temperature of from about 180° F. to about 380° F. Thus, for example, the present invention contemplates a packaging material in which the substrate comprises paper or paperboard, the oil resistant layer comprises polypropylene, and the heat seal layer comprises low density polyethylene. As another example, the heat seal layer comprises polypropylene, for example, metallocene polypropylene.

According to another aspect of the invention, a packaging material for a food item containing an oil comprises a substrate that is susceptible to discoloration by an oil, a tie layer substantially overlying the substrate, an oil resistant layer substantially overlying the tie layer, and a heat seal layer substantially overlying the oil resistant layer. The oil resistant layer comprises a polymer that is substantially resistant to penetration by oil.

Each of the various layers may be formed from numerous materials, and one or more layers may be formed from different polymers or the same polymers. In one example, the tie layer and the heat seal layer are formed from the same polymer. In another example, the tie layer and the heat seal layer are formed from different polymers. In one particular example, the substrate comprises paper or paperboard, the tie layer comprises low density polyethylene, the oil resistant layer comprises polypropylene, and the heat seal layer comprises low density polyethylene. In another example, one or both of the tie layer and the heat seal layer comprise polypropylene, for example, metallocene polypropylene.

Furthermore, the various layers may be present in any suitable amount. In one particular example, the paper or paperboard has a basis weight of from about 8 to about 250 lbs/ream, the tie layer has a basis weight of from about 0.1 to about 5 lbs/ream, the oil resistant layer has a basis weight of from about 0.1 to about 20 lbs/ream, and the heat seal layer has a basis weight of from about 1 to about 15 lbs/ream.

According to yet another aspect of the invention, a packaging material for masking staining by an oil comprises a substrate that tends to absorb oils, and at least one of an (1) opacity modifying additive and (2) a plurality of bleached fibers incorporated into the substrate. In one example, the opacity modifying additive comprises a white pigment, such as titanium dioxide. In another example, the substrate is formed from a plurality of fibers, where at least about 10 wt % of the fibers are bleached fibers. In one particular example, the substrate comprises paper having a basis weight of from about 30 to about 50 lbs/ream, including at least about 25 wt % bleached fiber, and the opacity modifying additive comprises at least about 90 lbs of titanium dioxide per ton of paper. In another particular example, the substrate comprises paper having a basis weight of from about 30 to about 50 lbs/ream, including at least about 50 wt % bleached fiber, and the opacity modifying additive comprises at least about 180 lbs of titanium dioxide per ton of paper.

According to still another aspect of the invention, a packaging material for masking staining by an oil comprises a substrate that tends to absorb oils, and an opacity modifying layer substantially overlying the substrate, where the opacity modifying layer comprises a polymer and an opacity modifying additive. In one example, the opacity modifying additive comprises titanium dioxide. In one variation of this aspect, the packaging material includes a tie layer positioned between the substrate and the opacity modifying additive layer. In another variation of this aspect, the packaging material includes a heat seal layer substantially overlying the opacity modifying layer distal the substrate. The various layers may be formed from any suitable material including, but not limited to, those described herein.

According to yet another aspect of the invention, a packaging material for masking staining by an oil comprises a substrate that tends to absorb oils, thereby creating a stain, and a stain masking layer overlying at least a portion of the substrate. The stain masking layer comprises a colorant that closely resembles the color of the stain, obscures the glossiness of the stain, is sufficiently opaque to conceal the stain, or any combination thereof. In one example, the colorant comprises a dark, non-reflective pigment that closely resembles the color of the stain, for example, a grey or black pigment. In another example, the colorant comprises a reflective pigment that obscures the glossiness of the stain, for example, aluminum flake, brass flake, a pearlescent pigment, or any combination thereof. In still another example, the colorant comprises a first, dark, non-reflective pigment that closely resembles the color of the stain, and a second, reflective pigment that obscures the glossiness of the stain. In one example, the colorant comprises from about 50 to about 99 wt % carbon black and from about 1 to about 50 wt % aluminum flake.

Various configurations of the stain masking layer are contemplated hereby. In one example, the stain masking layer overlies at least a portion of the substrate in a substantially continuous or solid configuration. In another example, the stain masking layer overlies at least a portion of the substrate in a patterned configuration. Thus, in one particular example, the colorant comprises carbon black and the stain masking layer overlies at least a portion of the substrate in a patterned configuration comprising lighter and darker shades of black.

In one variation, an opacity modifying additive, a plurality of bleached fibers, or any combination thereof may be incorporated into the substrate. In one example, the opacity modifying additive comprises titanium dioxide.

In another variation, the stain masking layer overlies at least a portion of a first side of the substrate, and the packaging material further comprises an opacity modifying layer overlying at least a portion of a second side of the substrate. In one example, the opacity modifying layer comprises a polymer and an opacity modifying additive, for example, titanium dioxide. Optionally, a tie layer may be positioned between the substrate and the opacity modifying layer.

According to still a further aspect of the invention, a packaging material for a food item containing an oil comprises a paper-based substrate that appears to be stained when brought into contact with an oil, a tie layer substantially overlying a first side of the substrate, an oil resistant layer substantially overlying the tie layer, a heat seal layer substantially overlying the oil resistant layer, and a stain masking layer overlying at least a portion of a second side of the substrate. The oil resistant layer may comprise a polymer that is substantially resistant to penetration by oil and an opacity modifying additive. The stain masking layer may comprise a colorant that closely resembles the color of the stain, obscures the glossiness of the stain, or any combination thereof. The colorant may comprise a first, dark, non-reflective pigment that closely resembles the color of the stain, and a second, reflective pigment that obscures the glossiness of the stain. In one variation, the colorant comprises from about 60 to about 80 wt % carbon black, and from about 20 to about 40 wt % aluminum flake.

In one variation, the tie layer comprises low density polyethylene, the polymer in the oil resistant layer comprises polypropylene, the opacity modifying additive comprises titanium dioxide, and the heat seal layer comprises low density polyethylene.

In another variation, the paper-based substrate has a basis weight of from about 8 to about 250 lbs/ream, the tie layer has a basis weight of from about 0.1 to about 5 lbs/ream, the oil resistant layer has a basis weight of from about 0.11 to about 20 lbs/ream, and the heat seal layer has a basis weight of from about 1 to about 15 lbs/ream.

Any of the various materials may be used to form a package, for example, for a food item containing an oily substance. In one particular example, any of the various materials may be used to form a conventional bag or other package for potato-based food items, such as French fries.

Other aspects and features of the present invention will become apparent in view of the figures and the following description.

### BRIEF DESCRIPTION OF THE DRAWINGS

The description refers to the accompanying drawings, some of which are schematic, in which like reference characters refer to like parts throughout the several views, and in which:

FIG. 1 schematically depicts a cross-sectional view of an exemplary packaging material according to various aspects of the present invention;

FIG. 2 schematically depicts a cross-sectional view of another exemplary packaging material according to various aspects of the present invention;

FIG. 3A schematically depicts a cross-sectional view of yet another exemplary packaging material according to various aspects of the present invention;

FIG. 3B schematically depicts an exemplary process for forming the material of FIG. 3A;

FIG. 4A schematically depicts a cross-sectional view of still another exemplary packaging material according to various aspects of the present invention; and

FIG. 4B schematically depicts an exemplary process for forming the material of FIG. 4A.

### DESCRIPTION

Various aspects of the present invention relate generally to a material for packaging a food item. More particularly, various aspects of the present invention relate generally to a material for packaging a food item that is coated with or contains an oily or greasy substance, for example, a trans fatty acid oil, a low trans fatty acid oil, a non-trans fatty acid oil, a saturated oil, an unsaturated oil, grease, or butter (collectively “oil” or “oils”), that potentially can penetrate one or more components of the packaging material. The packaging material of the present invention includes features for resisting penetration, masking penetration, or for both resisting and masking oil penetration. It will be understood that any combination of the techniques and features disclosed herein or contemplated hereby may be used alone or in any combination as needed or desired.

Any of the numerous packaging materials described herein or contemplated hereby may be used to form bags, cartons, carton blanks, or other packages or constructs for containing a food item therein. In one example, the packaging material is used to form a bag for containing a potato-based food item such as hash browns, French fries, or the like.

### Oil Resistant Materials

According to one aspect of the present invention, a packaging material is substantially resistant to penetration by oil. The packaging material may comprise a layered structure including one or more components that are susceptible to oil penetration and one or more components that are resistant to oil penetration. For example, the packaging material may include an oil permeable substrate coated with one or more additional layers that resist penetration by oil.

Various aspects of the invention may be illustrated by referring to the figures, which depict numerous examples of packaging materials and schematic processes for forming such materials. For purposes of simplicity, like numerals may be used to describe like features. It will be understood that where a plurality of similar features are depicted, not all of such features necessarily are labeled on each figure. Although several different exemplary aspects, implementations, and embodiments of the various inventions are provided, numerous interrelationships between, combinations thereof, and modifications of the various inventions, aspects, implementations, and embodiments of the inventions are contemplated hereby.

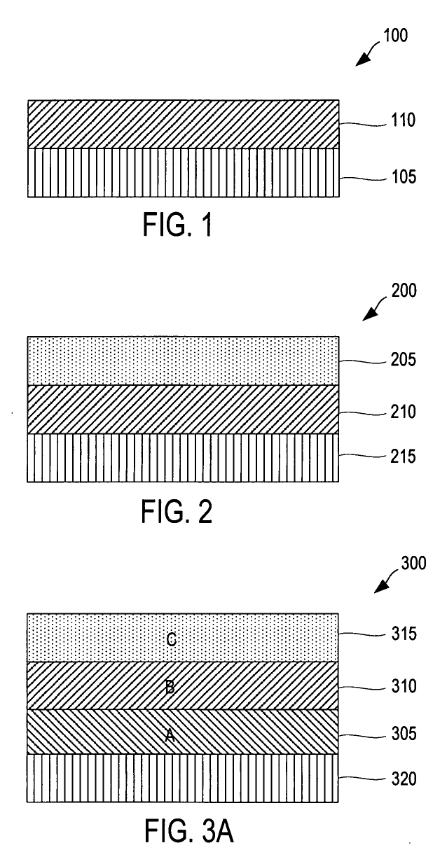

FIG. 1 depicts a schematic cross-sectional view of an exemplary packaging material 100 according to various aspects of the invention. The packaging material 100 may include a substrate 105 and an oil resistant layer 110 substantially covering or overlying the substrate 105.

The substrate 105 may be any material that is susceptible to penetration by oil, for example, a paper or paperboard. In this and other aspects of the invention, the paper or paperboard may be, for example, a bleached or unbleached Kraft paper, or may be a paper formed from a blend of natural Kraft unbleached fibers and bleached fibers. While paper-based substrates are described in detail herein, it will be understood that the oil resistant features described herein are applicable to any other type of substrate that is permeable to oil and, thus, subject to undesirable staining.

The oil resistant layer 110 may be formed from one or more materials that resist penetration by oil. In one aspect, the oil resistant layer comprises a resin, polymeric material, or film, for example, polypropylene, including various metallocene polypropylenes, polyethylene, including low density polyethylene, propylene-ethylene copolymers, including random propylene-ethylene copolymers, polyethylene terephthalate, nylon 6,6, polyvinylidene chloride, polyvinyl alcohol, ethylene vinyl alcohol, or any combination thereof. One example of a polypropylene that may be suitable for use with the present invention is available commercially from Chevron Phillips (Kingsport, Tenn.) under the trade name MARLEX®. One example of a polyethylene terephthalate that may be suitable for use with the present invention is available commercially from Toray Plastics (America), Inc. (Front Royal, Va.) under the trade name PA10. One example of a polyvinyl alcohol that may be suitable for use with the present invention is available commercially from DuPont (Wilmington, Del.) under the trade name ELVANOL®. One example of a polyvinylidene chloride that may be suitable for use with the present invention is available commercially from Dow Chemical Company (Midland, Mich.) under the trade name SARAN®. One example of an ethylene vinyl alcohol that may be suitable for use with the present invention is available commercially from Evalco (Houston, Tex.) under the trade name EVAL Resins. Another polymeric material that may be suitable is SURLYN®, a blend of ethylene/methacrylic acid copolymers commercially available from DuPont (Wilmington, Del.). Other materials are contemplated hereby.

The oil resistant layer may include various other additives and components as desired. The other additives and components may be selected to improve adhesion to the paper substrate or to other layers or components within the packaging material, may increase resistance to oil permeation, or may provide other functions or attributes. For example, polypropylene may be blended with other polymers, for example, thermoplastic polymers. In one particular example, polypropylene is blended with polyethylene, for example, low density polyethylene. In another example, polypropylene is blended with an organic or inorganic filler, for example, calcium carbonate, magnesium carbonate, silica, calcium oxide, alumina, titanium dioxide, any other filler, or any mixture thereof. In still another example, polypropylene is blended with low density polyethylene and calcium carbonate. While such examples are provided herein, numerous other additives and components are contemplated hereby. It will be understood that some of such fillers, additives, and components also may alter other characteristics, for example, the opacity, of one or more layers and/or the packaging material in its entirety.

When the oil resistant layer includes more than one polymer or other additive, each of the various components may have a weight percent greater than 0 up to 100 wt %. Thus, in each of various examples, the oil resistant layer independently may include from about 50 up to 100 wt % polypropylene and from 0 to about 50 wt % low density polyethylene, from about 60 to 100 wt % polypropylene and from 0 to about 40 wt % low density polyethylene, from about 70 to 100 wt % polypropylene and from 0 to about 30 wt % low density polyethylene, from about 80 to 100 wt % polypropylene and from 0 to about 20 wt % low density polyethylene, or from about 90 to 100 wt % polypropylene and from 0 to about 10 wt % low density polyethylene.

Numerous other combinations of materials are contemplated. For example, the oil resistant layer may include from about 50 to 100 wt % polypropylene, from 0 to about 50 wt % low density polyethylene, and from 0 to about 30 wt % filler, such as, for example, calcium carbonate. As another example, the oil resistant layer may include from about 15 to about 80 wt % polypropylene, from about 1 to about 40 wt % low density polyethylene, and from about 10 to about 30 wt % filler. As yet another example, the oil resistant layer may include from about 30 to about 80 wt % polypropylene, from about 10 to about 30 wt % low density polyethylene, and from about 5 to about 20 wt % filler.

Each of the various layers may have any suitable weight, and may be present in the packaging material in any suitable amount. The substrate, which may be, for example, paper or paperboard, may have a basis weight of from about 8 to about 250 lbs/ream. In one aspect, the substrate has a basis weight of from about 20 to about 50 lbs/ream. In another aspect, the substrate has a basis weight of from about 35 to about 45 lbs/ream.

The oil resistant layer generally may have a basis weight of from about 0.05 to about 25 lbs/ream. In one aspect, the oil resistant layer has a basis weight of from about 1 to about 10 lbs/ream. In another aspect, the oil resistant layer has a basis weight of from about 2 to about 6 lbs/ream. In yet another aspect, the oil resistant layer has a basis weight of from about 3 to about 5 lbs/ream. In still another aspect, the oil resistant layer has a basis weight of from about 1 to about 3 lbs/ream. In yet another aspect, the oil resistant layer has a basis weight of from about 2 to about 4 lbs/ream. In still another aspect, the oil resistant layer has a basis weight of from about 2 to about 5 lbs/ream.

FIG. 2 depicts another exemplary packaging material 200 according to the present invention. In this example, a heat seal layer 205 substantially overlies all or a portion of the oil resistant layer 210, which substantially overlies at least a portion of the substrate 215. A heat seal layer 205 may be used where, for example, thermal bonding is used to form a package (not shown) from the packaging material 200.

In this and other aspects, the heat seal layer may be formed from any suitable thermoplastic polymeric material. Generally, the heat seal layer may be formed from any material having a low melting or softening point, such that the heal seal can be initiated at a relatively low temperature, for example, from about 180° F. to about 380° F. (“heat seal temperature”). Additionally, the material used to form the heat seal layer may be selected to provide a wide hot tack sealing window, such that the heat seal may be formed over a range of temperatures with the desired duration and degree of tackiness.

By way of example, and not by limitation, the heat seal layer may comprise linear low density polyethylene, for example, a metallocene catalyzed linear low density polyethylene (or “metallocene polyethylene”). In another example, the heat seal layer may comprise low density polyethylene. Examples of low density polyethylenes that may be suitable include, but are not limited to, Westlake EC-482, commercially available from Westake Chemical Corp. (Houston, Tex.), VORIDIAN PE E6838-850P, commercially available from Eastman Chemical Company (Kingsport, Tenn.), and Marflex 1013 LDPE, commercially available from Chevron Phillips (The Woodlands, Tex.). In another example, the heat seal layer may comprise polyethylene, such as, for example, EXXCO 012 PE, commercially available from Exxon Mobil (Irving, Tex.), or any other suitable polyethylene. In still another example, the heat seal layer may be formed from a blend of ethylene/methacrylic acid copolymers, such as, for example, SURLYN® 1707 resin, commercially available from DuPont (Wilmington, Del.). In still another example, the heat seal layer may be formed from polypropylene, for example, a metallocene catalyzed polypropylene (or “metallocene polypropylene”). One example of a metallocene polypropylene that may be suitable for use with the invention is Affinity 1450, commercially available from Dow Chemical (Midland, Mich.). Other examples are contemplated.

In yet another example, the heat seal layer may be formed from a blend of polyethylene, low density polyethylene, and ethylene/methacrylic acid copolymers, such as, but not limited to, those described above. In various exemplary aspects, the blend independently may comprise from about 40 to about 80 wt % polyethylene, from about 15 to about 55 wt % low density polyethylene, and from about 1 to about 25 wt % ethylene/methacrylic acid copolymer; from about 50 to about 70 wt % polyethylene, from about 25 to about 45 wt % low density polyethylene, and from about 1 to about 15 wt % ethylene/methacrylic acid copolymer; from about 50 to about 70 wt % polyethylene, from about 25 to about 45 wt % low density polyethylene, and from about 1 to about 10 wt % ethylene/methacrylic acid copolymer; about 60 wt % polyethylene, about 35 wt % low density polyethylene, and about 5 wt % ethylene/methacrylic acid copolymer; or any other suitable blend or range of blends as desired.

In still another example, the heat seal layer may be formed from a blend of polyethylene, polypropylene, and ethylene/methacrylic acid copolymers, such as, but not limited to, those described above. In some examples, the polypropylene comprises a metallocene polypropylene. In various exemplary aspects, the blend independently may comprise from about 40 to about 80 wt % polyethylene, from about 15 to about 55 wt % polypropylene, and from about 1 to about 25 wt % ethylene/methacrylic acid copolymer; from about 50 to about 70 wt % polyethylene, from about 25 to about 45 wt % polypropylene, and from about 1 to about 15 wt % ethylene/methacrylic acid copolymer; from about 50 to about 70 wt % polyethylene, from about 25 to about 45 wt % polypropylene, and from about 1 to about 10 wt % ethylene/methacrylic acid copolymer; about 60 wt % polyethylene, about 35 wt % polypropylene, and about 5 wt % ethylene/methacrylic acid copolymer; or any other suitable blend or range of blends as desired.

Although particular examples are provided herein, it will be understood that other polymers, such as, but not limited to, any of those described herein, or any blends or copolymers thereof, may be used in accordance with the invention. For example, it may be desirable to blend the heat seal layer polymer with the polymer used to form the adjacent layer, in this example, the oil resistant layer. Alternatively, a portion of the heat seal layer polymer may be replaced with a copolymer of the heat seal layer polymer and the oil resistant layer polymer, such that the layers are more compatible and are able to attain better adhesion properties.

Thus, if desired, the heat seal layer may include from 0 to about 50 wt % of one or more polymers as a compatibilizing polymer, agent, or additive. In one particular example, the heat seal layer includes from 0 to about 40 wt % of one or more compatibilizing polymers. In another example, the heat seal layer includes from 0 to about 30 wt % of one or more compatibilizing polymers. In yet another example, the heat seal layer includes from 0 to about 20 wt % of one or more compatibilizing polymers. In still another example, the heat seal layer includes from 0 to about 10 wt % of one or more compatibilizing polymers. In yet a further example, the heat seal layer includes from 0 to about 5 wt % of one or more compatibilizing polymers.

As with the various other layers of the packaging material, the heat seal layer may be present in any suitable amount as needed or desired to achieve the desired heat seal. In one aspect, the heat seal layer has a basis weight of from about 0.1 to about 20 lbs/ream. In another aspect, the heat seal layer has a basis weight of from about 1 to about 15 lbs/ream. In another aspect, the heat seal layer has a basis weight of from about 3 to about 10 lbs/ream. In yet another aspect, the heat seal layer has a basis weight of from about 3.5 to about 9 lbs/ream. In still another aspect, the heat seal layer has a basis weight of from about 2 to about 6 lbs/ream.

Thus, an exemplary packaging material according to the present invention may include a layer of paper or paperboard having a basis weight of from about 8 to about 250 lbs/ream, a layer of an oil resistant polymer, for example, polypropylene, with optional additives, applied at a level of from about 0.1 to about 20 lbs/ream, and a heat seal layer having a basis weight of from about 1 to about 15 lbs/ream. Another exemplary packaging material may include a layer of paper or paperboard having a basis weight of from about 30 to about 60 lbs/ream, a layer of polypropylene with optional additives applied at a level of from about 2 to about 6 lbs/ream, and a heat seal layer having a basis weight of from about 3 to about 9 lbs/ream.

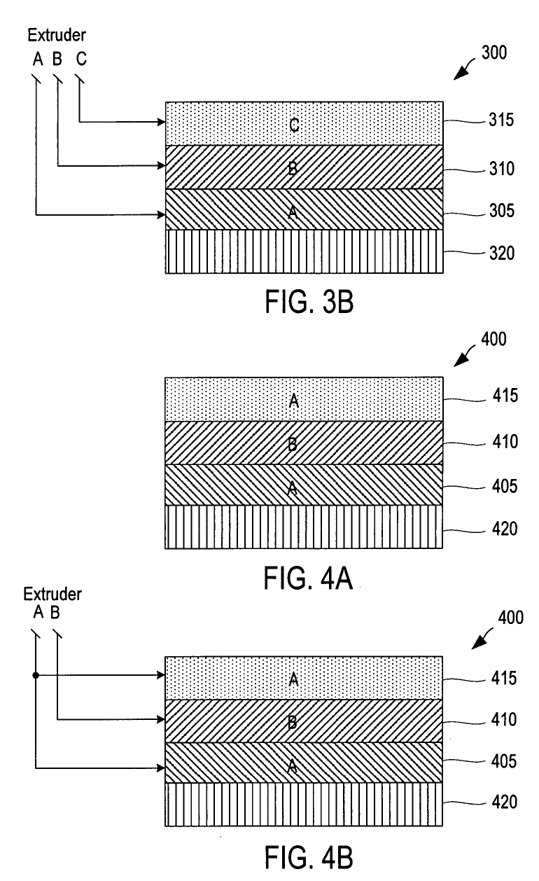

FIG. 3A depicts still another exemplary packaging material 300 according to the present invention. In this example, a plurality of polymer layers 305, 310, and 315 (also designated as layers A, B, and C, respectively) overlie a substrate 320, for example, paper or paperboard (described above). Each layer may serve one or more different functions within the structure. For example, polymer layer 305, which substantially overlies the substrate 320, may serve as a bonding or “tie” layer that joins polymer layer 310 to the substrate 320. A tie layer may be used, for example, where two adjacent layers, in this example, polymer layer 310 and substrate 320, are incompatible or otherwise unable to attain sufficient adhesion. A tie layer may be located between two polymer layers or two paper layers, or between a paper layer and a polymer layer. Other uses for such layers are contemplated hereby.

A tie layer in accordance with this and other aspects of the invention may be formed from any suitable polymer that sufficiently adheres to the adjacent layers to join them. In one example, the tie layer is formed from a low density polyethylene, for example EC-482, described above. In another example, the tie seal layer may be formed from polypropylene, for example, a metallocene polypropylene. However, it will be understood that other polymers, and blends or copolymers thereof, may be used in accordance with the invention. For example, it may be desirable to blend the tie layer polymer with the polymer used to form the adjacent layer, in this example, the oil resistant layer. Alternatively, a portion of the tie layer polymer may be replaced with a copolymer of the tie layer polymer and the oil resistant layer polymer, such that the layers are more compatible and are able to attain better adhesion properties.

Thus, if desired, the tie layer may include from 0 to about 50 wt % of one or more polymers as a compatibilizing polymer, agent, or additive. In one particular example, the tie layer includes from 0 to about 40 wt % of one or more compatibilizing polymers. In another example, the tie layer includes from 0 to about 30 wt % of one or more compatibilizing polymers. In yet another example, the tie layer includes from 0 to about 20 wt % of one or more compatibilizing polymers. In still another example, the tie layer includes from 0 to about 10 wt % of one or more compatibilizing polymers. In yet a further example, the tie layer includes from 0 to about 5 wt % of one or more compatibilizing polymers.

The tie layer may have any suitable basis weight as needed to attain the desired level of adhesion with the adjacent layers. For example, the tie layer may have a basis weight of from about 0.1 to about 5 lbs/ream. Other basis weights are contemplated hereby.

Still viewing FIG. 3A, polymer layer 310, which lies substantially between polymer layer 305 and polymer layer 315, may serve as an oil resistant layer. Such a layer may be formed from any suitable polymer and may have any suitable basis weight, as described above. For example, polymer layer 310 may comprise polypropylene and, optionally, one or more other polymers and/or fillers. As another example, polymer layer 310 and may have a basis weight of from about 0.1 to about 20 lbs/ream, for example, from about 2 to about 6 lbs/ream. Other polymers, compositions, and basis weights are contemplated hereby.

Polymer layer 315, which substantially overlies polymer layer 310, may serve as a heat seal layer. Such a layer may be formed from any suitable polymer and may have any suitable basis weight, as described above. For example, polymer layer 315 may comprise polypropylene and, optionally, one or more other polymers. As another example, polymer layer 315 may have a basis weight of from about 1 to about 15 lbs/ream, for example, from about 3 to about 5 lbs/ream. Other polymers, compositions, and basis weights are contemplated hereby.

In this and other aspects, the various packaging materials according to the invention may be formed in any suitable manner using one or more techniques known to those of skill in the art. In one example, each layer 305, 310, and 315 of the material 300 is formed using a separate extruder, as shown schematically in FIG. 3B. One or more of the layers may be coextruded or, alternatively, may be formed and/or joined in a sequential manner. Numerous other processes are contemplated hereby.

If desired, one or more of the layers may be formed from the same type of polymer, as shown in FIGS. 4A and 4B. In this exemplary packaging material 400, a plurality of polymer layers 405, 410, and 415 substantially overlie a substrate 420, for example, paper or paperboard (described above). Polymer layers 405 and 415 each are designated as being formed from polymer type A, and polymer layer 410 is designated as being formed from polymer type B. In this example, polymer layer 405, which substantially overlies the substrate 420, may serve as a bonding or tie layer that joins the various other polymer layers 410 and 415 to the substrate 420. Polymer layer 410, which lies substantially between polymer layer 405 and polymer layer 415, may serve as an oil resistant layer. Polymer layer 415, which substantially overlies polymer layer 410, may serve as a heat seal layer. Examples of basis weights and compositions for the various layers are provided throughout this specification and numerous others are contemplated hereby.

The packaging material 400 may be formed in any suitable manner. For example, one extruder may be used to form polymer layers 405 and 415, and another may be used to form polymer layer 410, as shown schematically in FIG. 4B. One or more of the layers may be coextruded or, alternatively, may be formed and/or joined in a sequential manner. Numerous other processes are contemplated hereby.

It will be understood that numerous other structures and packaging materials are contemplated hereby. For example, a four layer structure is contemplated in which a first tie layer is compatible with and substantially overlies the substrate, a second tie layer is compatible with and substantially lies between the first tie layer and an oil resistant layer, and a heat seal layer substantially overlies the oil resistant layer. As another example, a five layer structure is contemplated in which a third tie layer substantially lies between the heat seal layer and the oil resistant layer.

If desired, the layers of any of the various packaging materials of the invention may be selected to provide a security feature within the package. For example, a first polymer layer adjacent to the substrate may be selected to have a weaker bond than a second polymer layer adjacent to the first polymer layer. With such an arrangement, it has been discovered that if an attempt is made to open the package, the seal tends to fail at the interface between the substrate and the first polymer layer. Where the substrate is paper, the paper tends to tear and cannot be resealed. Thus, the user may be alerted to the possibility that the package has been tampered with, contaminated, or has been compromised otherwise. In one particular example, the substrate comprises paper, the first polymer layer comprises polypropylene, for example, metallocene polypropylene, and the second polymer layer also comprises polypropylene, for example, metallocene polypropylene. Numerous other possibilities are contemplated.

Alternatively, if it is desirable to have the package be capable of being resealed, the first polymer layer adjacent to the substrate may be selected to have a stronger bond than the second polymer layer adjacent to the first polymer layer. In such an arrangement, the seal tends to fail at the interface between the first polymer layer and the second polymer layer, which typically can be resealed. In one particular example, the substrate comprises paper, the first polymer layer comprises polyethylene, for example, linear low density polyethylene, and the second polymer layer comprises polypropylene.

The present invention also contemplates a method of making a packaging material having increased resistance to permeation by oil. The method includes providing a substrate that may be permeable to oil and, therefore, subject to staining, and substantially overlying at least a portion of the substrate with an oil resistant material or layer, for example, a resin or polymeric film. The oil resistant layer may include one or more additives optionally added to resin or film to impart additional functional characteristics, such as color, absorbency, improved adhesion, oil repellency, or numerous other attributes. A heat seal layer may be applied or joined to at least a portion of the oil resistant layer to allow the packaging material to be sealed. One or more tie layers may be included to improve adhesion between various other layers. Still other layers may be incorporated to serve various other functions.

The various layers of the packaging material may be formed, assembled, and/or joined using any method or technique known in the art. Thus, for example the polymeric layers may be coextruded and laminated to the paper layer. In another example, each layer may be formed independently and laminated together using heat, adhesive, mechanical fastening, or other joining or binding technique. In yet another example, the polymeric layers may be extruded directly onto the paper layer, concurrently or sequentially. Numerous other processes are contemplated hereby.

In this and other aspects, the packaging material may be formed into any suitable package, for example, a bag. The bag may have any shape and size as needed for a particular food item and application. For some applications, for example, for French fries, the bags may include slits or other features to permit the air to escape after filling the bag. This allows a plurality of bags to be packed more efficiently into boxes or other cartons for shipping.

Any suitable process may be used to form and fill the bag. In many of such processes, heat is used to seal the open ends of the package together. However, any suitable adhesive, mechanical fastening, joining, or binding technique may be used with the present invention.

### Oil Masking Materials

According to another aspect of the present invention, a packaging material includes features that mask oil penetration of a substrate. It has been found that oil often causes the substrate to become translucent or transparent, thereby creating a visible stain on, for example, paper or paperboard, particularly where there is a seam, abrasion, aperture, or slit through the material. Accordingly, at least a portion of the substrate may be modified to mask the appearance of a darkened region created by oil penetration.

Various approaches for masking a stain are contemplated by this invention. Examples of such approaches include, but are not limited to, use of one or more opacity modifying additives, use of opacity modifying fibers, use of one or more colorants, and use of various printing patterns to minimize the appearance of a darkened region of a substrate. The opacity modifying additives, colorants, or combination thereof, may be applied or incorporated throughout the material, may be applied or incorporated in a pattern, may be selectively applied or incorporated in particular areas, may be applied or incorporated in a somewhat random manner, or any combination thereof, as appropriate.

Opacity modifying additives may be used in numerous ways to mask the appearance of oil stains. Examples of opacity modifying additives that may be suitable for use with the present invention include titanium dioxide, calcium carbonate, talc, or clay, and any combination thereof. It will be understood that some opacity modifying additives are also colorants, and that some colorants are also opacity modifying additives.

In one aspect, an opacity modifying additive may be incorporated into the substrate to make the substrate more white and opaque. In one particular example, titanium dioxide is added to the substrate. For example, from about 20 to about 180 lb/ton titanium dioxide may be added to a paper having a basis weight of from about 15 to about 160 lbs/ream, or in any amount needed to achieve the desired results. In one particular example, from about 20 to about 180 lb/ton titanium dioxide may be added to a paper having a basis weight of from about 30 to about 50 lbs/ream.

In another aspect, a layer of polymer containing titanium dioxide or other opacity modifying additive may be coated onto, extruded onto, laminated to, or otherwise applied to the substrate. To do so, the opacity modifying additive may be blended or compounded with a polymer and subsequently metered into an extruder, so that the polymer extrusion contains a substantially uniform amount of the opacifying agent. Such layers may be added, for example, as one or more layers of a multilayer structure, such as those described above, or may be applied directly to the substrate without other polymer layers. Where such a polymer layer is used, the packaging material may be formed into a package such that the opacified polymer layer lies on the inside of the package in contact with the food item and/or on the outside of the package, as needed or desired for a particular application.

In still another aspect, where the substrate is paper-based, bleached fibers that tend to be whiter may be used to form the substrate instead of or in addition to unbleached wood pulp fibers. Generally, from 0 to 100 wt % of the fibers used to form the substrate may be bleached fibers. In each of various examples, the substrate independently may be formed from about 10 to 100 wt % bleached fibers and from 0 to about 90 wt % unbleached fibers, from about 20 to 100 wt % bleached fibers and from 0 to about 80 wt % unbleached fibers, from about 30 to 100 wt % bleached fibers and from 0 to about 70 wt % unbleached fibers; from about 40 to 100 wt % bleached fibers and from 0 to about 60 wt % unbleached fibers, from about 50 to 100 wt % bleached fibers and from 0 to about 50 wt % unbleached fibers, from about 60 to 100 wt % bleached fibers and from 0 to about 40 wt % unbleached fibers, from about 70 to 100 wt % bleached fibers and from 0 to about 30 wt % unbleached fibers, from about 80 to 100 wt % bleached fibers and from 0 to about 20 wt % unbleached fibers, or from about 90 to 100 wt % bleached fibers and from 0 to about 10 wt % unbleached fibers. Other ranges and ratios of fiber types are contemplated hereby.

In yet another aspect, the fiber content of the substrate may include at least about 10 wt % bleached fiber. In each of various other examples, the fiber content of the substrate independently may include at least about 15 wt % bleached fiber, at least about 20 wt % bleached fiber, at least about 25 wt % bleached fiber, at least about 30 wt % bleached fiber, at least about 35 wt % bleached fiber, at least about 40 wt % bleached fiber, at least about 45 wt % bleached fiber, at least about 50 wt % bleached fiber, at least about 55 wt % bleached fiber, at least about 60 wt % bleached fiber, at least about 65 wt % bleached fiber, at least about 70 wt % bleached fiber, at least about 75 wt % bleached fiber, at least about 80 wt % bleached fiber, at least about 85 wt % bleached fiber, or at least about 90 wt % bleached fiber. In still another example, the fiber content of the substrate may include at least about 90 wt % bleached fiber. In each example, the remaining fibers may be unbleached fibers or any other suitable fiber.

In another example, the substrate may have a basis weight of from about 30 to about 50 lbs/ream, for example 40 lbs/ream, and may include at least about 25 wt % bleached fibers, and the opacity modifying additive comprises at least about 90 lbs of titanium dioxide per ton of paper. In still another example, the substrate may have a basis weight of from about 30 to about 50 lbs/ream, for example 40 lbs/ream, and may include at least about 25 wt % bleached fibers, and the opacity modifying additive comprises at least about 90 lbs of titanium dioxide per ton of paper.

The opacity of the unmodified substrate may depend on numerous factors, for example, what the substrate is formed from and what the basis weight of the substrate is. Thus, by adding an opacity modifying additive, opacity modifying fibers, or opacity modifying layers, the opacity of the substrate may increase in various relative amounts. For example, in each of various examples, the modified substrate independently may have an opacity that is from about 5 to about 20 percent greater than the unmodified substrate, from about 20 to about 40 percent greater than the unmodified substrate, from about 40 to about 60 percent greater than the unmodified substrate, from about 60 to about 80 percent greater than the unmodified substrate, from about 80 to about 100 percent greater than the unmodified substrate, from about 100 to about 120 percent greater than the unmodified substrate, from about 120 to about 140 percent greater than the unmodified substrate, from about 140 to about 160 percent greater than the unmodified substrate, from about 160 to about 180 percent greater than the unmodified substrate, or from about 180 to about 200 percent greater than the unmodified substrate. Still greater differences in opacity are contemplated hereby.

In still another aspect of the invention, the appearance of an oil stain may masked by a colorant applied to the surface of the substrate viewed by the user. As used herein, the term “colorant” means to any substance designed to impart color to the surface of the substrate. Thus, the term colorant is intended to include, for example, pigments, inks, paints, or any combination thereof. Colorants also may modify other attributes of the material, such as opacity and brightness, as will be known to those in the art.

The colorant type and composition selected and amount applied to or incorporated into the substrate may vary depending on the type of substrate chosen, the basis weight of the substrate, the modified or natural opacity of the substrate, the type of food item being packaged, the amount of oil on the food item, the degree of staining that occurs, the color of the stain on the substrate, and whether a combination of techniques are used to mask the appearance of staining. Thus, while various examples are provided herein, it will be understood the numerous other combinations of substrates and colorants are contemplated hereby.

In each of various examples, the colorant composition may be applied in an amount of from about 0.1 to about 10 lbs/ream, from about 0.5 to about 8 lbs/ream, from about 0.7 to about 5 lbs/ream, from about 0.8 to about 3.5 lbs/ream, from about 1 to about 3 lbs/ream, about 1 lbs/ream, about 1.25 lbs/ream, about 1.5 lbs/ream, about 1.75 lbs/ream, about 2 lbs/ream, about 2.25 lbs/ream, about 2.5 lbs/ream, about 2.75 lbs/ream, about 3 lbs/ream, or in any other amount as needed or desired for a particular application.

In one aspect, the specific color of the colorant may be chosen to resemble closely or to overpower the appearance of a stain on the substrate caused by oil permeating through the substrate. In this manner, the colorant serves to mask the stain and, thus, to prevent the user from detecting the oil stain on the outside surface of the finished package. While the use of any color is contemplated hereby, dark colors, such as black or grey, may be particularly suitable for concealing the color variation associated with an oil stain. Such colors absorb a full, or nearly full, spectrum of light, thereby blocking or concealing the portions of the substrate that have become transparent or translucent due to oil staining. Furthermore, it may be advantageous to use an inorganic colorant. Such colorants tend to be more opaque, as compared with organic pigments, which often are somewhat translucent.

For example, the colorant may include carbon black, titanium dioxide, or various combinations thereof. A typical composition may include from about 0.25 to about 5 dry lbs/ream (3000 sq. ft.) carbon black ink solids (or “non-volatiles”) and from about 10 to about 180 lbs/ton titanium dioxide in the substrate. In one aspect, the colorant composition includes from about 0.35 to about 3 dry lbs/ream carbon black ink solids and from about 20 to about 150 lbs/ton titanium dioxide. In another aspect, the colorant composition includes from about 0.4 to about 2 dry lbs/ream carbon black ink solids and from about 40 to about 140 lbs/ton titanium dioxide. In yet another aspect, the colorant composition includes from about 0.5 to about 2 dry lbs/ream carbon black ink solids and from about 50 to about 135 lbs/ton titanium dioxide in the substrate.

The masking efficiency of the ink or other colorant may be enhanced using a metallic or other reflective pigment. While not wishing to be bound by theory, the presence of such a pigment in the ink or colorant composition is believed to enhance stain masking because the metallic ink reflects light, thereby obscuring the glossy appearance of the oil stained substrate. Examples of reflective pigments that may be suitable for use with the present invention include aluminum flake, brass flake, pearlescent pigments, or other light reflecting pigments, or any combination thereof. Some examples of pearlescent pigments that may be suitable for use with the present invention include those offered by EM Industries, Inc. Some examples of reflective pigments that may be suitable for use with the present invention are available from Benda-Lutz Co. under the trade names Blitz Aluminum Powders and Blitz Goldbronze Powder. Other materials are contemplated hereby.

Thus, in one aspect, a colorant composition used in accordance with the present invention may include a pigment that sufficiently conceals the color of an oil stain on the particular substrate, for example, a non-reflective pigment. In another aspect, a colorant composition used in accordance with the present invention may include a pigment that sufficiently obscures the glossiness associated an oil stain on the particular substrate, for example, a reflective pigment. In yet another aspect, a colorant composition may include a first pigment, for example, a non-reflective pigment, that conceals the color of an oil stain and a second pigment, for example, a reflective pigment, that obscures the glossiness associated with the oil stain.

Thus, in each of various examples, the pigment independently may include from 0 to about 10 wt % reflective pigment and from about 90 to 100 wt % non-reflective pigment, from about 10 to about 20 wt % reflective pigment and from about 80 to 90 wt % non-reflective pigment, from about 20 to about 30 wt % reflective pigment and from about 70 to 80 wt % non-reflective pigment, from about 30 to about 40 wt % reflective pigment and from about 60 to 70 wt % non-reflective pigment, from about 40 to about 50 wt % reflective pigment and from about 50 to 60 wt % non-reflective pigment, from about 50 to about 60 wt % reflective pigment and from about 40 to 50 wt % non-reflective pigment, from about 60 to about 70 wt % reflective pigment and from about 30 to 40 wt % non-reflective pigment, from about 70 to about 80 wt % reflective pigment and from about 20 to 30 wt % non-reflective pigment, from about 80 to about 90 wt % reflective pigment and from about 10 to 20 wt % non-reflective pigment, or from about 90 to 100 wt % reflective pigment and from 0 to 10 wt % non-reflective pigment.

In each of various other examples, the pigment independently may include from 0 to about 10 wt % aluminum flake and from about 90 to 100 wt % carbon black, from about 10 to about 20 wt % aluminum flake and from about 80 to 90 wt % carbon black, from about 20 to about 30 wt % aluminum flake and from about 70 to 80 wt % carbon black, from about 30 to about 40 wt % aluminum flake and from about 60 to 70 wt % carbon black, from about 40 to about 50 wt % aluminum flake and from about 50 to 60 wt % carbon black, from about 50 to about 60 wt % aluminum flake and from about 40 to 50 wt % carbon black, from about 60 to about 70 wt % aluminum flake and from about 30 to 40 wt % carbon black, from about 70 to about 80 wt % aluminum flake and from about 20 to 30 wt % carbon black, from about 80 to about 90 wt % aluminum flake and from about 10 to 20 wt % carbon black, or from about 90 to 100 wt % aluminum flake and from 0 to 10 wt % carbon black.

In each of still other examples, the pigment independently may include from about 1 to about 50 wt % aluminum flake and from about 50 to about 99 wt % carbon black, from about 20 to about 40 wt % aluminum flake and from about 60 to about 80 wt % carbon black, from about 30 to about 50 wt % aluminum flake and from about 50 to about 90 wt % carbon black, from about 20 to about 60 wt % aluminum flake and from about 40 to about 80 wt % carbon black, from 0 to about 50 wt % aluminum flake and from about 50 to 100 wt % carbon black, or any other amount or range of amounts of each component.

If desired, the one or more pigments may be blended into a stable emulsion of binder, vehicle, wax, and dispersing liquid, such as water or another suitable solvent, to form a colorant composition.

It will be understood that the various opacity modifying additives, opacity modifying fibers, and/or colorants (collectively “masking additives”) described herein or contemplated hereby may be incorporated into the material in any suitable manner. In one example, the masking additive may be incorporated into the substrate during formation of the substrate. Thus, where the substrate is paper or paperboard, the additive may be added during the wet end processing of the pulp. Where the masking additive is an opacity modifying additive, opacity modifying fiber, or colorant, this advantageously may result in a substantial distribution of additive throughout the bulk of the substrate.

In another example, the masking additive may be applied to the substrate after formation. Thus, for example, where the masking additive is a colorant, the colorant may be applied to the surface of the substrate. Any suitable process may be used, including any of numerous spraying, roll coating, brush coating, saturating, printing, foaming, and other techniques. In one particular example, printing may be used to apply a colorant to achieve a very thin, uniform layer to the surface of the substrate.

Any combination of processes may be used to form a material according to the present invention. Thus, for example, one colorant, such as carbon black, may be printed on the outside, and another colorant, such as titanium dioxide, may be added to the paper as a wet end constituent.

In each of the various aspects discussed herein, it will be understood by those of skill in the art that one or more processing additives may be incorporated into any of the various compositions or layers as needed or desired. Thus, for example, some such layers or compositions may include surfactants, anti-foaming agents, plasticizers, and additives to modify abrasion resistance and slip. Other processing additives are contemplated hereby.

According to yet another aspect of the present invention, stain masking may be enhanced by applying or incorporating the colorant in a solid, patterned, or random configuration. In some instances, a random printing pattern or randomly printed pattern may enhance masking of stains by camouflaging the variation in color of the stained substrate, for example, where the stains tend to appear around exhaust air slits in the package. In other instances, a solid or patterned configuration may achieve the desired degree of masking.

It will be understood that any combination of techniques and features described herein or contemplated hereby may be used in accordance with the invention. Various aspects of the present invention are illustrated further by the following examples, which are not to be construed as limiting in any manner.

### Oil Resistance Test

Various samples were evaluated according to the following procedure:

First, a 6 inch by 10 inch sample sheet is provided. Two hard folds are made on one side of the sample material, so the two folds make a cross right at the center of one side of the pouch. The sheet is folded in half and the short sides are sealed carefully. One tablespoon of sand is placed into a beaker to which add 1 plastic eye-dropper of red-dyed non-trans fatty acid oil is added and mixed. The red, oily sand is spooned into the pouch, making sure not to contaminate the seal area with sand or oil. The sides of the pouch are pressed to remove as much air as possible. The open end of the pouch is heat sealed. Any sample in which the seal is contaminated, creased, or otherwise not well formed is discarded. Five sample pouches are prepared and placed on blotter paper.

For room temperature evaluation, each batch of five samples is observed at room temperature, typically at about 72° F. and about 50% humidity, for signs of red oil soak-thru every hour for the first two hours, and then about every 3 hours thereafter for 24 hours.

For evaluation at 50° C., each batch of five samples is placed in an oven maintained at about 50° C. The samples are observed for red oil soak-thru about every 20 minutes for the first two hours, and then every hour thereafter for 24 hours.

For evaluation at 80° C., each batch of five samples is placed in an oven maintained at about 80° C. The samples are observed for red oil soak-thru about every 10 minutes for the first hour, every 30 minutes thereafter for 8 hours, and thereafter every 3 hours for 24 hours.

The amount of red stain at each time interval is reported and averaged. A sample has failed when about 25% of the surface shows red oil soak-thru.

### EXAMPLE 1

Use of an oil resistant layer in the packaging material was evaluated. A an about 2 lbs/ream layer of low density polyethylene obtained from Westlake Chemical Corp. (Houston, Tex.) under the trade name EC 482 was applied to natural Kraft paper having a basis weight of about 38 lbs/ream. An about 4 lbs/ream layer of polypropylene obtained from Phillips Sumika under the trade name Marlex then was extruded onto the rough, uncoated side of the Kraft paper. The layers successfully adhered to one another. An about 4 lbs/ream layer of EC 482 LDPE including heat seal additives then was extruded on top of the polypropylene as the heat seal layer. Using the Oil Resistance Test, the oil resistant material effectively resisted penetration of Wesson canola oil, a non-trans fatty acid oil.

### EXAMPLE 2

Use of an oil resistant layer in the packaging material was evaluated. A blend of 68 wt % polypropylene obtained from Phillips Sumika under the trade name MARLEX, 20 wt % low density polyethylene obtained from Westlake Chemical Corp. (Houston, Tex.) under the trade name EC 482, and 12 wt % calcium carbonate obtained from Bayshore under the trade name BL-910 was prepared. The calcium carbonate was added to improve adhesion to the substrate. About 4 lbs/ream of the composition was extrusion coated onto natural Kraft paper having a basis weight of about 38 lbs/ream. An about 4 lbs/ream layer of EC 482 LDPE including heat seal additives then was extruded on top of the polypropylene as the heat seal layer. This composition effectively adhered to the paper substrate and provided good resistance to non-trans fatty acid oil as measured by the Oil Resistance Test.

### EXAMPLE 3

The effectiveness of a masking colorant composition including a metallic pigment was compared with composition without a metallic pigment. The compositions evaluated are presented below.

### Ink Formulation I (Black)

about 20 wt % carbon black pigment

about 23 wt % other components (e.g., binder, resin, surfactant, wax)

remainder water

### Ink Formulation II “Pewter” (Slight Metallic Cast)

about 14 wt % carbon black pigment

about 4.7 wt % aluminum flake

about 21 wt % other components (e.g., binder, resin, surfactant, wax)

remainder water

### Ink Formulation III (Metallic Silver-Black)

about 6.7 wt % carbon black pigment

about 9.8 wt % aluminum flake

about 20 wt % other components (e.g., binder, resin, surfactant, wax)

remainder water

### Ink Formulation IV (Black with Slight Metallic Cast)

about 17.48 wt % carbon black pigment

about 7.77 wt % aluminum flake

about 69.88 wt % other components (e.g., binder, resin, surfactant, wax)

remainder water

The ink compositions were coated onto the smooth side of the paper in amount of about 1 lb dry/ream. Then, about 6 lbs/ream of low density polyethylene was extrusion coated onto the wire side of paper having a basis weight of about 40 lbs/ream. The various compositions effectively masked staining, as indicated in Table 1.

TABLE 1

| | Formula I | Formula II | Formula III | Formula IV |
|---|---|---|---|---|
| Description | Carbon black | Carbon black | Carbon black | Carbon black |
| | | w/aluminum | w/aluminum | w/aluminum |
| | | flake | flake | flake |
| | | (6.15:1) | (2.26:1) | (2.25:1) |
| Masking | Fair masking; | Excellent | Outstanding | Superb |
| Effectiveness | grease stain | masking; | masking; oil | masking; oil |
| | faint but | visible on | stains barely | stains barely |
| | discernible | close | discernible | discernible |
| | | inspection | | |

### EXAMPLE 4

The independent effect and the combined effect of using an opacity modifier and/or bleached fibers was evaluated. The results are presented in Table 2.

TABLE 2

| lbs TiO2/ton of | | | |
|---|---|---|---|
| about 40 | Bleached fiber* | Bleached fiber | Bleached fiber |
| lbs/ream paper | 0% | 25% | 50% |
| 0 | Stain highly visible | | Stain masked but |
| | | | still visible |
| 54 | | Some masking | |
| | | achieved | |
| 90 | | Good masking | |
| | | achieved | |
| 180 | Stain masked but | | Stain barely |
| | still visible | | visible |

*remainder is unbleached natural Kraft fiber

### EXAMPLE 5

Use of a printed masking pattern was evaluated. A flexographic print plate was prepared from a picture of a large tub of potatoes. The picture included light and dark areas that define the shape of potatoes. Formulae I, II, and III of Example 3 were printed onto a natural Kraft paper having a basis weight of about 40 lbs/ream in the desired pattern. The results are presented in Table 3.

TABLE 3

| | Formula I | Formula II | Formula III |
|---|---|---|---|
| Masking | Good; grease | Excellent; | Superb; oil stains |
| Effectiveness | stain faint but | stain is scarcely | nearly invisible even |
| | discernible | visible on close | with close inspection |
| | | inspection | discernible |

### EXAMPLE 6

A flexible, substantially two-dimensional, oil resistant packaging material was formed from a layer of paper coated with an oil resistant polymer. The coated paper was formed into a pouch or package in which oily products were sealed and handled. Oil stains that typically are visible on the outside of the sealed package were less visible or not visible at all.

### EXAMPLE 7

A black ink was printed in a solid configuration on the outside surface of the packaging material of Example 6, thereby rendering oil stains more difficult to see compared to non-printed portions of the paper.

### EXAMPLE 8

An ink containing about 96% carbon black and about 4% finely divided aluminum pigment was printed in a solid configuration on the outside surface of the packaging material of Example 6. Oil stains were masked effectively.

### EXAMPLE 9

An ink containing about 10% finely divided aluminum and about 90% carbon black was printed in a solid configuration on the outside surface of the packaging material of Example 6. Oil stains were masked effectively.

### EXAMPLE 10

A 100 % carbon black ink was printed onto the outside surface of the packaging material of Example 6 in various configurations. A random printing pattern of lighter and darker shades was more effective at stain masking than a solid printing pattern.

### EXAMPLE 11

An ink containing about 96% carbon black and about 4% finely divided aluminum was printed onto the outside surface of the packaging material of Example 6 in various configurations. A random printing pattern was more effective at masking stains than a solid printing pattern.

### EXAMPLE 12

An ink containing about 90% carbon black and about 10% finely divided aluminum was printed onto the outside surface of the packaging material of Example 6 in various configurations. A random printing pattern was more effective at masking stains than a solid printing pattern.

Although certain embodiments of this invention have been described with a certain degree of particularity, those skilled in the art could make numerous alterations to the disclosed embodiments without departing from the spirit or scope of this invention. All directional references (e.g., over, under, inner, outer, upper, lower, upward, downward, left, right, leftward, rightward, top, bottom, above, below, vertical, horizontal, clockwise, and counterclockwise) are used only for identification purposes to aid the reader's understanding of the various embodiments of the present invention, and do not create limitations, particularly as to the position, orientation, or use of the invention unless specifically set forth in the claims. Joinder references (e.g., joined, attached, coupled, connected, and the like) are to be construed broadly and may include intermediate members between a connection of elements and relative movement between elements. As such, joinder references do not necessarily imply that two elements are connected directly and in fixed relation to each other.

It will be recognized by those skilled in the art, that various elements discussed with reference to the various embodiments may be interchanged to create entirely new embodiments coming within the scope of the present invention. It is intended that all matter contained in the above description or shown in the accompanying drawings shall be interpreted as illustrative only and not limiting. Changes in detail or structure may be made without departing from the spirit of the invention. The detailed description set forth herein is not intended nor is to be construed to limit the present invention or otherwise to exclude any such other embodiments, adaptations, variations, modifications, and equivalent arrangements of the present invention.

Accordingly, it will be readily understood by those persons skilled in the art that, in view of the above detailed description of the invention, the present invention is susceptible of broad utility and application. Many adaptations of the present invention other than those herein described, as well as many variations, modifications, and equivalent arrangements will be apparent from or reasonably suggested by the present invention and the above detailed description thereof, without departing from the substance or scope of the present invention.

While the present invention is described herein in detail in relation to specific aspects, it is to be understood that this detailed description is only illustrative and exemplary of the present invention and is made merely for purposes of providing a full and enabling disclosure of the present invention and to provide the best mode contemplated by the inventor or inventors of carrying out the invention. The detailed description set forth herein is not intended nor is to be construed to limit the present invention or otherwise to exclude any such other embodiments, adaptations, variations, modifications, and equivalent arrangements of the present invention.

What is claimed is:

1. An oil resistant packaging material comprising:
a substrate that is susceptible to discoloration by an oil; and
an oil resistant layer substantially overlying the substrate,
wherein the oil resistant layer comprises a polymer that is substantially resistant to penetration by oil.

2. The packaging material of claim 1, wherein the oil resistant layer comprises a single polymer.

3. The packaging material of claim 1, wherein the oil resistant layer comprises polypropylene.

4. The packaging material of claim 5, wherein the oil resistant layer has a basis weight of from about 1 to about 10 lbs/ream.

5. The packaging material of claim 5, wherein the oil resistant layer has a basis weight of from about 2 to about 6 lbs/ream.

6. The packaging material of claim 1, wherein the oil resistant layer comprises a blend of two or more polymers.

7. The packaging material of claim 1, wherein the oil resistant layer comprises:
from about 50 to 100 weight % polypropylene; and
up to about 50 weight % low density polyethylene, propylene-ethylene copolymer, polyethylene terephthalate, nylon 6,6, polyvinylidene chloride, polyvinyl alcohol, ethylene vinyl alcohol, or any combination thereof.

8. The packaging material of claim 1, wherein the oil resistant layer comprises a filler.

9. The packaging material of claim 1, wherein the oil resistant layer comprises from 0 to about 30 weight % filler.

10. The packaging material of claim 1, wherein
the substrate comprises paper or paperboard; and
the oil resistant layer comprises polypropylene and a filler selected from the group consisting of calcium carbonate, magnesium carbonate, silica, calcium oxide, alumina, titanium dioxide, and any combination thereof.

11. The packaging material of claim 1, further comprising a heat seal layer substantially overlying the oil resistant layer.

12. The packaging material of claim 11, wherein the heat seal layer comprises a thermoplastic polymer having a softening temperature of from about 180° F. to about 380° F.

13. The packaging material of claim 11, wherein
the substrate comprises paper or paperboard;
the oil resistant layer comprises polypropylene; and
the heat seal layer comprises metallocene polypropylene.

14. A packaging material for a food item containing an oil, comprising:
a substrate that is susceptible to discoloration by an oil;
a tie layer substantially overlying the substrate;
an oil resistant layer substantially overlying the tie layer, the oil resistant layer comprising a polymer that is substantially resistant to penetration by oil; and
a heat seal layer substantially overlying the oil resistant layer.

15. The packaging material of claim 14, wherein
the substrate comprises paper or paperboard;
the tie layer comprises metallocene polypropylene;
the oil resistant layer comprises polypropylene; and
the heat seal layer comprises metallocene polypropylene.

16. The packaging material of claim 14, wherein
the paper or paperboard has a basis weight of from about 8 to about 250 lbs/ream;
the tie layer has a basis weight of from about 0.1 to about 5 lbs/ream;
the oil resistant layer has a basis weight of from about 0.1 to about 20 lbs/ream; and
the heat seal layer has a basis weight of from about 1 to about 15 lbs/ream.

17. The packaging material of claim 14, wherein the tie layer and the heat seal layer are formed from the same polymer.

18. The packaging material of claim 14, wherein the tie layer and the heat seal layer are formed from different polymers.

19. A packaging material for masking staining by an oil, comprising:
a substrate that tends to absorb oils; and
at least one of an opacity modifying additive and a plurality of bleached fibers incorporated into the substrate.

20. The packaging material of claim 19, wherein the substrate includes an opacity modifying additive comprising a white pigment.

21. The packaging material of claim 19, wherein the substrate includes an opacity modifying additive comprising titanium dioxide.

22. The packaging material of claim 19, wherein the substrate is formed from a plurality of fibers, and at least 10 weight % of the fibers are bleached fibers.

23. The packaging material of claim 19, wherein
the substrate comprises paper having a basis weight of from about 30 to about 50 lbs/ream, including at least about 25 weight % bleached fiber, and
the opacity modifying additive comprises at least about 90 lbs of titanium dioxide per ton of paper.

24. The packaging material of claim 19, wherein
the substrate comprises paper having a basis weight of from about 30 to about 50 lbs/ream, including at least about 50 weight % bleached fiber, and
the opacity modifying additive comprises at least about 180 lbs of titanium dioxide per ton of paper.

25. A packaging material for masking staining by an oil, comprising:
a substrate that tends to absorb oils; and
an opacity modifying layer substantially overlying the substrate, the opacity modifying layer comprising a polymer and an opacity modifying additive.

26. The packaging material of claim 25, wherein the opacity modifying additive comprises titanium dioxide.

27. The packaging material of claim 25, further comprising a tie layer positioned between the substrate and the opacity modifying layer.

28. The packaging material of claim 25, further comprising a heat seal layer substantially overlying the opacity modifying layer distal the substrate.

29. A packaging material for masking staining by an oil, comprising:
a substrate that tends to absorb oils, thereby creating a stain; and
a stain masking layer overlying at least a portion of the substrate, the stain masking layer comprising a colorant, wherein the colorant closely resembles the color of the stain, obscures the glossiness of the stain, or any combination thereof.

30. The packaging material of claim 29, wherein the colorant comprises a dark, non-reflective pigment that closely resembles the color of the stain.

31. The packaging material of claim 29, wherein the colorant comprises a reflective pigment that obscures the glossiness of the stain.

32. The packaging material of claim 29, wherein the reflective pigment comprises aluminum flake, brass flake, a pearlescent pigment, or any combination thereof.

33. The packaging material of claim 29, wherein the colorant comprises a first, dark, non-reflective pigment that closely resembles the color of the stain, and a second, reflective pigment that obscures the glossiness of the stain.

34. The packaging material of claim 29, wherein the colorant comprises:
from about 50 to about 99 weight % carbon black; and
from about 1 to about 50 weight % aluminum flake.

35. The packaging material of claim 29, wherein the stain masking layer overlies at least a portion of the substrate in a substantially continuous configuration.

36. The packaging material of claim 29, wherein the stain masking layer overlies at least a portion of the substrate in a patterned configuration.

37. The packaging material of claim 29, wherein the colorant comprises carbon black and the stain masking layer overlies at least a portion of the substrate in a patterned configuration comprising lighter and darker shades of black.

38. The packaging material of claim 29, wherein an opacity modifying additive, a plurality of bleached fibers, or any combination thereof is incorporated into the substrate.

39. The packaging material of claim 38, wherein the opacity modifying additive comprises titanium dioxide.

40. The packaging material of claim 29, wherein
the stain masking layer overlies at least a portion of a first side of the substrate, and
the packaging material further comprises an opacity modifying layer overlying at least a portion of a second side of the substrate.

41. The packaging material of claim 40, wherein the opacity modifying layer comprises a polymer and an opacity modifying additive.

42. The packaging material of claim 41, wherein the opacity modifying additive comprises titanium dioxide.

43. The packaging material of claim 41, further comprising a tie layer positioned between the substrate and the opacity modifying layer.

44. A packaging material for a food item containing an oil, comprising:
a paper-based substrate that appears to be stained when brought into contact with an oil;
a tie layer substantially overlying a first side of the substrate;
an oil resistant layer substantially overlying the tie layer, the oil resistant layer comprising
a polymer that is substantially resistant to penetration by oil, and
an opacity modifying additive;
a heat seal layer substantially overlying the oil resistant layer; and
a stain masking layer overlying at least a portion of a second side of the substrate, the stain masking layer comprising a colorant,
wherein the colorant
closely resembles the color of the stain,
obscures the glossiness of the stain, or
any combination thereof.

45. The packaging material of claim 44, wherein
the tie layer comprises low density polyethylene;
the polymer in the oil resistant layer comprises polypropylene;
the opacity modifying additive comprises titanium dioxide; and
the heat seal layer comprises low density polyethylene.

46. The packaging material of claim 44, wherein
the paper-based substrate has a basis weight of from about 8 to about 250 lbs/ream;
the tie layer has a basis weight of from about 0.1 to about 5 lbs/ream;
the oil resistant layer has a basis weight of from about 0.1 to about 20 lbs/ream; and
the heat seal layer has a basis weight of from about 1 to about 15 lbs/ream.

47. The packaging material of claim 44, wherein the colorant comprises:
a first, dark, non-reflective pigment that closely resembles the color of the stain; and
a second, reflective pigment that obscures the glossiness of the stain.

48. The packaging material of claim 44, wherein the colorant comprises:
from about 60 to about 80 weight % carbon black; and
from about 20 to about 40 weight % aluminum flake.

49. A package formed from the packaging material of claim 44.

50. A package formed from the packaging material of claim 44 for containing potato-based food items.
